(19) United States
(12) Patent Application Publication
(10) Pub. No.: US 2002/0034432 A1
(43) Pub. Date: Mar. 21, 2002

(54) Lift device for a front-mounting attachment

(76) Inventors: Hagen Schmidt, Furth (DE); Georg Hornfischer, Muhr am See (DE)

Correspondence Address: Bachman & LaPointe, P.C., Suite 1201, 900 Chapel Street, New Haven, CT, 06510-2802, US

(21) Appl. No.: 09/777,601

(22) Filed: Feb. 6, 2001

(30) Foreign Application Priority Data
Sep. 18, 2000 (DE) 200 16 152 . 0

(51) Int. Cl. B66F 9/00

(52) U.S. Cl. 414/723; 414/722; 414/920

(57) ABSTRACT

A lift device for a front-mounting attachment, for example for a small tractor, comprises a pair of lower links pivotable about a first axis on the vehicle and a central upper link pivotable about a second axis parallel to the first axis. The first axis is positioned relative to the first links in such a way as to divide each of them into a forwardly extending lever arm and a rearwardly extending lever arm. A central piston-cylinder unit is centrally connected between end portions of the rearwardly extending lever arms, which are remote from the first axis, and a fixed mounting point with respect to the vehicle, for operative pivotal movement of the links to raise or lower the attachment.

### FIELD OF THE INVENTION

The invention concerns a lift device for a front-mounting attachment for a vehicle, for example a small or lightweight tractor.

### BACKGROUND OF THE INVENTION

A typical design configuration of a lift device for mounting a front-mounting attachment to a vehicle such as a small tractor comprises a pair of lower links or arms which are pivotable about a first axis which is fixed with respect to the vehicle, and a central upper link or arm which is pivotable on the vehicle about a second axis parallel to the first axis. A central piston-cylinder unit is connected to the lower links to produce the appropriate pivotal movement thereof about the first axis.

A lift device of that kind is to be found for example in DE 36 04 053 A1, and the front-mounting attachment for example may be a rotary sweeper brush, a suction and/or blower unit or the like.

In the lift device disclosed in the above-indicated specification, the two lower links are each in the form of a single-armed lever insofar as the first axis about which the lower links are pivotable is disposed at an end portion of each of the lower links, which end portion is towards the vehicle. The piston-cylinder unit engages the two lower links, in a central part thereof, and accordingly between the pivot mounting axis and the free ends thereof. For that purpose, the lower links are connected together by means of a transverse member, with that rigid connection between the lower links serving to apply thereto the actuating force generated by the piston-cylinder unit. That rigid connection however can have an adverse effect on the uniformity of application of the actuating forces involved.

### SUMMARY OF THE INVENTION

An object of the present invention is to provide a lift device for a front-mounting attachment for a vehicle, with a central piston-cylinder unit so arranged that only a small amount of space is taken up thereby.

Another object of the present invention is to provide a lift device for a front-mounting attachment for a vehicle such as a lightweight tractor, of such a design configuration that a front power take-off shaft on the vehicle is still readily accessible without encumbrance by the lift device.

Yet another object of the present invention is to provide a lift device for a front-mounting attachment for a vehicle, which is of a simple structure such as to also ensure that the application of force when lifting the attachment is of optimum uniformity.

Still a further object of the invention is to provide a vehicle such as a lightweight tractor which has a lift device of a simple but reliable structure which operates efficiently even under robust operating conditions.

In accordance with the principles of the present invention the foregoing and other objects are attained by a lift device for a front-mounting attachment for a vehicle, comprising a pair of first links which in use constitute lower links and which are pivotable about a first axis which is fixed with respect to the vehicle on which the lift device in use is mounted. The lift device further includes a central second link which in use constitutes an upper link and which is pivotable about a second axis parallel to the first axis. The first and second links carry mounting means for mounting the front-mounting attachment thereto. The lift device further includes a central piston-cylinder unit which is connected to the lower links for pivoting them about their first axis. The lower links are each in the form of a two-arm lever having a first lever arm which in the installed condition of the lift device extends forwardly of the vehicle and a second lever arm which in the installed condition of the device extends rearwardly of the vehicle. The first axis is disposed between the forwardly extending and rearwardly extending lever arms. The piston-cylinder unit is connected centrally to end portions of the rearwardly extending lever arms, said end portions being remote from the first axis.

In a preferred feature of the invention, the two lower links are connected together in the region between the forwardly extending and the rearwardly extending lever arms by means of a sleeve element through which extends a spindle or shaft forming the first axis about which the lower links are pivotable.

A preferred feature of the invention provides that the lift device has a third axis which is parallel to the first axis and which extends through the end portions of the two rearwardly extending lever arms, which end portions are remote from the first axis. The third axis can be formed for example by a shaft or spindle to which the piston-cylinder unit is connected, thereby to provide for the above-mentioned optimally uniform application of force to the two lower links by the centrally disposed piston-cylinder unit. That third axis is connected to the rearwardly extending lever arms not rigidly but axially limited movably so as to permit a given degree of lateral equalisation and compensation movement.

A further preferred feature of the invention provides that each of the two lower links has a lift arm recess or pocket associated with the first axis, and a front lift arm which can be fitted into and fixed in the corresponding lift arm pocket. That arrangement affords the advantage that it is possible for the lower links to be removed from or fitted to the vehicle as required, in a simple and time-saving procedure which does not require a great deal of force. For carrying out that operation, it is only necessary for the lift arms at the front side to be fitted into the associated lift arm pockets and fixed therein for example by means of push-in pins or if necessary for the front lift arms to be removed from the lift arm pockets after the fixing pins have been released.

In a further preferred feature the lift arm pockets are fixedly connected together by means of the sleeve element which is operatively associated with the first axis, in which case the two lift arm pockets and the sleeve element jointly form a structural unit.

In accordance with another preferred feature of the invention the two lift arm pockets include with each other an acute angle which opens forwardly in relation to the vehicle to which the lift device is mounted. Such a design configuration has the advantage that the above-mentioned third axis which is engaged by the piston-cylinder unit can be of a correspondingly short size, which has an advantageous effect on the mechanical strength properties involved and on the way in which forces are applied to the lift device.

In accordance with a further preferred feature of the invention, each lift arm pocket comprises first and second mutually parallel bar or plate portions, between which extends a transverse web portion. The two bar portions are provided with first holes which are each axially aligned with each other. At its rearward insertion end portion which fits into the respective lift arm pocket, the respective lift arm can have an insertion slot and second and third holes which are provided in alignment with the first holes in the bar portions. The two first holes in the bar portions of the respective pocket and the second hole in the rearward insertion end portion of the corresponding lift arm can be play-free adapted to an insertion projection member while the third hole is in the form of a slot. Consequently the second holes are fitting holes with which the respective components can be located relative to each other, while the third hole in each case is a motion hole which thus permits relative movement as between the components involved. When the respective insertion projection member is fitted into the first and second holes, the lift arm is fixedly connected without play in positively locking relationship to the associated lift arm pocket. When the insertion projection member is fitted into the other first holes of the associated lift arm pocket, which are provided in alignment with the third hole in the respective lift arm, then the lift arm can perform a limited pivotal movement about the associated transverse web portion, that is to say, it enjoys a limited motion play. That can be particularly advantageous when the front-mounting attachment on the respective vehicle is used on uneven or sloping ground.

Further objects, features and advantages of the invention will be apparent from the description hereinafter of a preferred embodiment of the invention.

### BRIEF DESCRIPTION OF THE DRAWING

FIG. 1 is a diagrammatic side view showing a part of a vehicle carrying a lift device for a front-mounting attachment on the vehicle,

FIG. 2 is a view in section taken along section line II-II in FIG. 1 through part of each of the two lower links shown,

FIG. 3 is a side view of a part of a lower link comprising a lift arm pocket of which a portion is shown and a front lift arm of which a portion is shown and which can be inserted into the lift arm pocket, with the front lift arm being shown in a condition of being separated in space from the associated lift arm pocket,

FIG. 4 is a side view generally similar to FIG. 3 showing the lower link, with the front lift arm fitted into the associated lift arm pocket and mechanically fixedly connected thereto to form the respective lower link, and

FIG. 5 is a view of the lift arm pockets and associated lift arms of FIG. 3 viewing from above in the direction indicated by the arrow V.

### DESCRIPTION OF THE PREFERRED EMBODIMENT

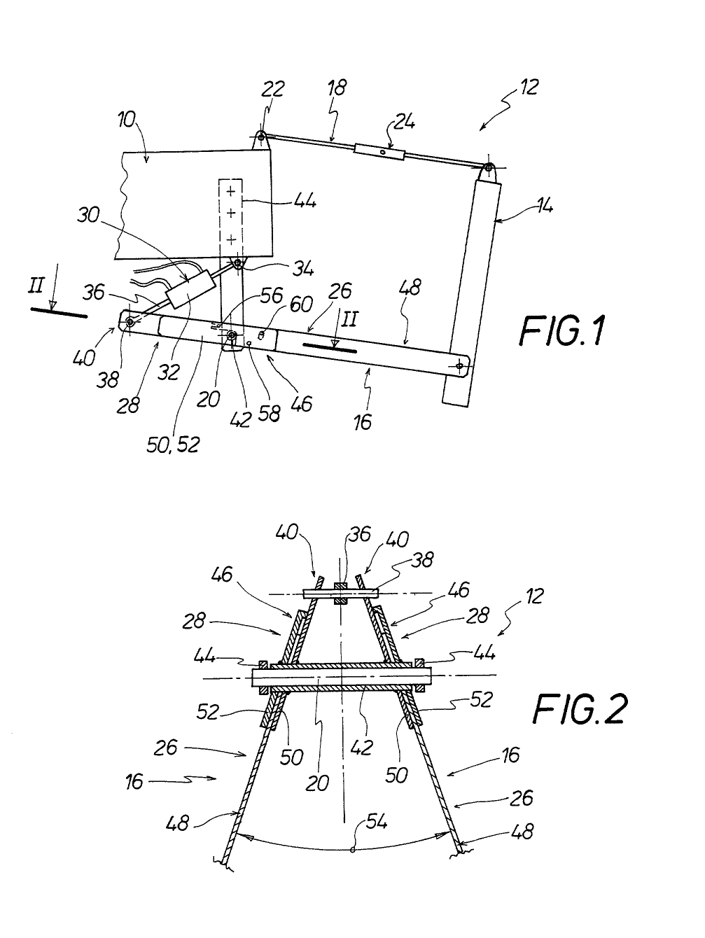

Referring firstly to FIG. 1, shown therein as a diagrammatic side view is the front part of a vehicle as indicated by reference numeral 10, more particularly for example a small or lightweight tractor as is used in small-scale projects and situations such as in communes, landscape gardenings or the like. The vehicle 10 is connected by means of a lift device 12 to a front-mounting attachment or implement 14 which for example can have a rotary sweeper brush, a suction or blower unit or the like.

The lift device 12 comprises a pair of first links 16 which in the installed condition of the device as illustrated in FIG. 1 constitute lower links, and a second link 18 which in the installed condition of the device constitute an upper link 18 which is arranged centrally in relation to the lower links 16 and thereabove. The two lower links 16 which are thus laterally spaced from each other are pivotable about a first axis indicated at 20 which is fixed with respect to the vehicle, being formed for example by a suitable shaft or spindle. The central upper link 18 is pivotable about a second axis 22 which is also fixed with respect to the vehicle. The second axis 22 is oriented in parallel relationship to the first axis 20. The two lower links 16 and the central upper link 18 are pivotably movably connected to the front-mounting attachment 14 in such a way that the lower links 16 and the central upper link 18 form a four-joint parallelogram. To compensate for possible dimensional tolerances in terms of implementing the parallelogram structure, the central upper link 18 is desirably divided into first and second portions to permit it to be adjusted as desired in respect of its length by means of a screwthreaded adjusting sleeve 24 into which the respective portions of the upper link 18 are suitably screwed.

The two lower links 16 are each in the form of a two-arm lever with a front lever arm 26 which thus extends forwardly of the vehicle 10 from the axis 20 and a rearward lever arm 28 which thus extends rearwardly of the vehicle 10 from the axis 20. It will be seen therefore that the first axis 20 about which the lower links 16 are pivotable for raising and lowering the front-mounting attachment 14 is disposed between the front lever arms 26 and the rear lever arms 28.

The two lower links 16 are connected to a centrally disposed piston-cylinder unit 30. More specifically, the cylinder 32 is connected to the vehicle 10 by means of a connecting shaft or spindle indicated at 34 in FIG. 1 while the end of the piston rod 36 of the piston-cylinder unit 30, which is remote from the cylinder 32, is connected by means of a third axis as indicated at 38 in FIG. 1 and shown in the form of a spindle 38 in FIG. 2 to the lower links 26 at the rear lever arms 28 thereof. It will be seen that the third axis 38 extends through end portions 40 of the rearward lever arms 28 of the two lower links 16, with those end portions 40 being remote from the first axis 20, whereby the piston-cylinder unit 30 is operatively connected to the end portions 40 of the rearward lever arms 28 of the lower links 16.

Reference will now also be made to FIG. 2 showing that the two lower links 16 diverge downwardly in FIG. 2, that is to say from the rearward end portions 40 towards the front ends of the lower links 16. The two lower links 16 are fixedly connected together by means of a sleeve element 42 between the front lever arms 26 and the associated rear lever arms 28. The spindle or shaft forming the first axis 20 for pivotally mounting the lower links 16 extends through the sleeve element 42. The first axis 20 is fixed between two fixing bars indicated at 44 in FIG. 2 and also clearly visible at 44 in FIG. 1, extending downwardly from the vehicle 10 and serving to mount the lift device thereto.

Reference will now additionally be made to FIGS. 3 through 5 to describe how each of the two lower links 16 has a structural configuration defining a lift arm pocket 46 which is associated with and disposed in close proximity to the first axis 20, and a front lift arm 48 which can be inserted into the corresponding lift arm pocket 46 and fixed therein. The front lift arm 48 of each lower link 16 thus extends forwardly from the lift arm pocket 46 in which it is received. As can be seen from FIG. 2 and in greater detail from FIG. 5, each lift arm pocket 46 is formed by an inner bar portion 50 and an outer bar portion 52 which is disposed at a defined spacing therefrom in at least substantially parallel relationship therewith. The sleeve element 42 form the spindle or shaft providing the first axis 20 extends through the two outer and inner bar portions 52 and 50 respectively and is fixedly connected thereto, the third axis 38 extends through the two inner bar portions 50 as can be seen from FIG. 2, and is secured therein to allow at most only limited axial movement of the axis 38 relative to the inner bar portions 50.

As can further be seen from FIGS. 2 and 5, the two lift arm portions 46 include with each other a forwardly opening acute angle which is indicated by the arcuate arrow 54.

Looking now at FIGS. 1, 3, 4 and 5, each lift arm pocket 46 has a transverse leg or bar 56 which extends between the respective inner bar portion 50 and the associated outer bar portion 52. The two bar portions 50 and 52 of the respective lift arm pocket are formed with two mutually spaced first holes whose positions can be clearly seen at 58 and 60 in FIG. 3. The first holes 58 in each of the bar portions 50 and 52 are axially aligned with each other, and similarly the first holes 60 in each of the bar portions 50 and 52 are also aligned with each other. As is clearly visible in FIG. 3, the respective lift arm 48 is provided at its rearward insertion end portion 62 adapted to fit into the respective lift arm pocket 46 with an insertion slot 64 which opens towards the respective free end of the end portion 62, that is to say, it is open in a rearward direction in relation to the generality of the lower link 16. The internal transverse dimension of the insertion slot 64 is adapted to the dimensions of the associated transverse leg or bar 56 between the bar portions 50 and 52.

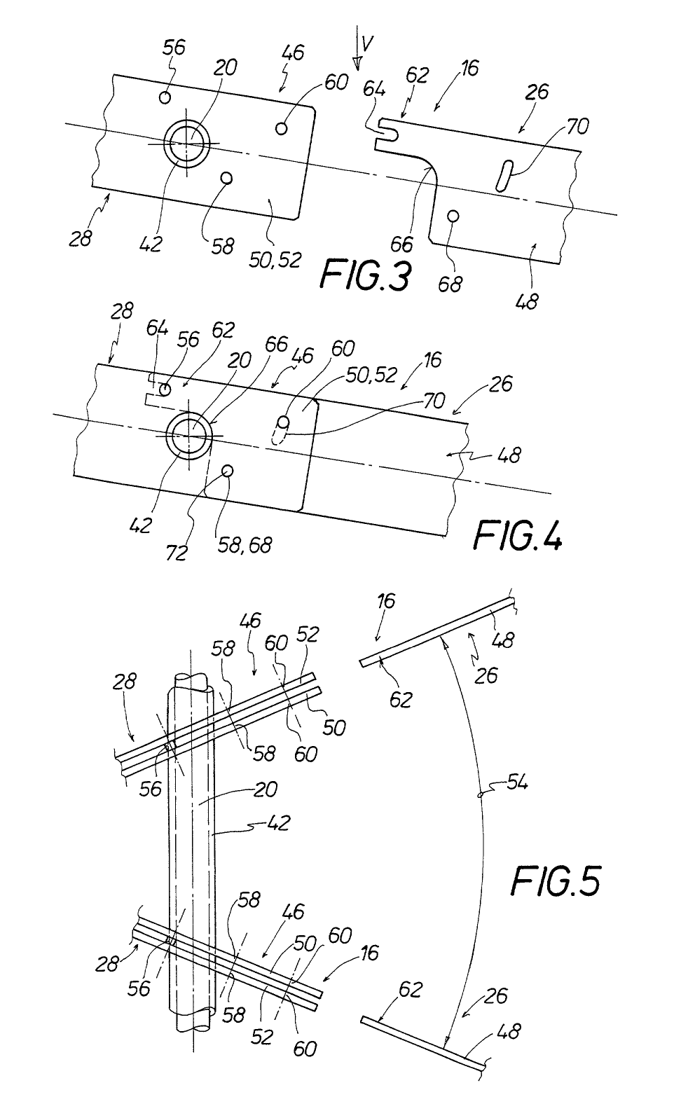

The respective lift arm 48 also has a contact shoulder 66 as well as a second hole indicated at 68 in FIG. 3 and a third hole indicated at 70 in FIG. 3. The second hole 68 is adapted in terms of shape to the mutually axially aligned first holes 58 in the bar portions 50 and 52 of the respective lift arm pocket 46. The third hole 70 is in the form of a slot. Thus, in the assembled condition, that is to say when the lift arm 48 is inserted with its rearward insertion end portion 62 between the bar portions 50 and 52 of the respective lift arm pocket 46, the shoulder 66 of the insertion end portion 62 bears against the sleeve element 42 which fixedly connects the two lift arm pockets 46 together, in the condition which can be clearly seen from FIG. 4.

If, in the assembled condition, that is to say with the lift arm 48 in the condition of being inserted into the lift arm pocket 46, an insertion pin member indicated at 72 in FIG. 4 is inserted through the aligned first holes 58 and the second hole 68 which in that installed condition is thus also in alignment with the first holes 58 and secured to prevent axial displacement, then that provides that the lift arm 48 is immovably connected to the associated lift arm pocket 46 in which it is fitted. If in comparison the insertion pin member 72 is fitted through the other first holes 60 in the corresponding lift arm pocket 46 and through the third hole 70 in the form of the slot of the associated lift arm 48, then the lift arm 48 can perform a defined limited pivotal movement about the transverse bar 56, between the two bar portions 50 and 52 defining the lift arm pocket 46.

It will be appreciated that the above-described structure has been set forth solely by way of example and illustration of the principles of the invention and that various other modifications and alterations may be made therein without thereby departing from the spirit and scope of the invention.

What is claimed is:

1. A lift device for a front-mounting attachment for a vehicle, comprising
a pair of first links which in the installed condition of the lift device constitute lower links,
a first axis which in the installed condition is fixed with respect to the vehicle and about which said first links are pivotable,
wherein the first links are each in the form of a two-arm lever comprising a first lever arm which in the installed condition of the lift device constitutes a front lever arm and a second lever arm which in the installed condition of the lift device constitutes a rear lever arm, the first axis being disposed between the first and second lever arms of each of said first links and the second lever arms having end portions remote from said first axis,
a second link which in the installed condition of the lift device constitutes a central upper link,
a second axis which is parallel to the first axis and about which the second link is pivotable, and
a piston-cylinder unit connected centrally to said end portions of said second lever arms.

2. A lift device as set forth in claim 1 and further including
a sleeve member fixedly interconnecting said first links in the region between the first and second lever arms thereof, said first axis extending through said sleeve member.

3. A lift device as set forth in claim 1 and further including
a third axis which is parallel to the first axis and which is connected to the piston-cylinder unit, said third axis extending through said end portions of said second lever arms.

4. A lift device as set forth in claim 1
wherein each of said first links comprises means defining a lift arm pocket associated with the first axis and a front lift arm engageable into the corresponding lift arm pocket,
and means for fixing said lift arm in said lift arm pocket.

5. A lift device as set forth in claim 2
wherein each of said first links comprises means defining a lift arm pocket associated with the first axis and a front lift arm engageable into the corresponding lift arm pocket, and means for fixing said lift arm in said lift arm pocket,
and wherein the lift arm pockets of the respective links are fixedly connected together by means of said sleeve member.

6. A lift device as set forth in claim 5
wherein the lift arm pockets include with each other an acute angle which opens forwardly.

7. A lift device as set forth in claim 4
wherein each lift arm pocket has first and second mutually parallel bar portions and a transverse web portion extending therebetween,
wherein the bar portions are provided with first and second mutually spaced first holes which are respectively in mutual axial alignment,
wherein at its rearward insertion end portion the respective lift arm has an insertion slot adapted to said transverse web portion and a second and a third hole which are provided in alignment with the first holes,
wherein the two first holes and the second hole are play-free adapted to an insertion member, and
wherein said third hole is in the form of a slot.

8. A lift device for a front-mounting attachment for a vehicle, comprising
means for mounting the lift device to a vehicle,
a pair of first links which in the installed condition of the lift device form lower links,
a first pivot means pivotably mounting said first links, said first pivot means being so positioned relative to said first links as to divide each of the first links into a first lever arm and a second lever arm, the first lever arm in the installed condition of the lift device extending forwardly of the vehicle relative to the first pivot means and the second lever arm in the installed condition of the lift device extending rearwardly of the vehicle relative to the first pivot means, the second lever arms each having an end portion remote from the first pivot means,
means on the lower links for mounting a front-mounting attachment thereto,
a second link which in the installed condition of the lift device forms a central upper link,
a second pivot means parallel to the first pivot means and adapted for pivotably mounting said second link, and
a piston-cylinder unit operatively connected to said end portions of said second lever arms centrally therebetween for pivoting said first links about said first pivot means.

9. On a vehicle a lift device for a front-mounting attachment, comprising
means mounting the lift device to the vehicle,
a pair of lower links,
a first pivot means pivotably mounting said lower links and so positioned relative to said lower links as to divide each of the lower links into a first lever arm and a second lever arm, the first lever arm extending forwardly of the vehicle relative to the first pivot means and the second lever arm extending rearwardly of the vehicle relative to the first pivot means, the second lever arms each having an end portion remote from the first pivot means,
mounting means on the lower links for mounting a front-mounting attachment thereto,
a central upper link,
a second pivot means parallel to the first pivot means and pivotably mounting said upper link,
mounting means on the upper link for mounting the front-mounting attachment thereto, and
a piston-cylinder unit having a first end operatively connected to said end portions of said second lever arms centrally therebetween and a second end connected to a fixed point in relation to the vehicle for pivotal actuation of said links.
